(19) United States
(12) Patent Application Publication
(10) Pub. No.: US 2013/0041761 A1
(43) Pub. Date: Feb. 14, 2013

(54) LOCATION BASED ADVERTISING ASSET TRACKING SYSTEM AND METHOD

(71) Applicant: JEFFREY ALLEN VODA, Long Beach, CA (US)

(72) Inventor: JEFFREY ALLEN VODA, Long Beach, CA (US)

(21) Appl. No.: 13/441,840

(22) Filed: Apr. 7, 2012

Related U.S. Application Data
(60) Provisional application No. 61/473,129, filed on Apr. 7, 2011.

(51) Int. Cl. G06Q 30/02

(52) U.S. Cl. 705/14.68

(57) ABSTRACT

An apparatus for tracking an advertising object is disclosed. A mobile device is capable of receiving an identification code to identify the advertising object. An identification device associated with the advertising object is capable of transmitting the identification code to the mobile device. A location media is capable of providing location information to the mobile device. A first set of executable instructions is capable of executing on a mobile device to detect the reception of the identification code, and forwarding the identification code and the location information to a server that is capable of storing the location information and the identification code.

### RELATED APPLICATION INFORMATION

This application claims priority from U.S. Provisional Application Ser. No. 61/473,129 entitled “Location Based Advertising Asset Tracking System And Method” filed Apr. 7, 2011.

### FIELD OF THE INVENTION

The invention relates to an advertising asset tracking and payment system and method. Specifically, an advertising asset tracking system and method allows advertisers to verify and compensate advertising asset users.

### SUMMARY

According to one preferred embodiment, an apparatus for tracking an advertising object comprises a mobile device capable receiving an identification code to identify the advertising object; an identification device associated with the advertising object capable of transmitting the identification code to the mobile device; a location media capable of providing location information to the mobile device; a first set of executable instructions capable of executing on a mobile device to detect the reception of the identification code, and forwarding the identification code and the location information to a server that is capable of storing the location information and the identification code.

### BRIEF DESCRIPTION OF THE DRAWINGS

FIG. 1 is diagrammatic view of general components used by the invention according to one embodiment;

FIG. 2 is a block diagram illustrating some of the functional modules of a mobile device illustrated in the embodiment of FIG. 1;

FIG. 3 is a database entity diagram showing one embodiment of how received data packages may be stored according the embodiment of FIG. 1;

FIG. 4 is a flow diagram illustrating the steps performed by a fulfilment software program to determine the amount owed to each user based on the data from the database of FIG. 3;

FIG. 5 is a flow diagram illustrating steps that may be performed by an application executing on the mobile device of the embodiment of FIG. 1;

FIG. 6 is a diagram illustrating an example a wireless referral that may appear on a recipient's mobile phone after transmission by the mobile device of FIG. 1;

FIG. 7 is a flow diagram illustrating steps for providing an incentive and/or extra compensation to the participants of a group assembly advertising program using the system of FIG. 1;

FIG. 8 is a flow diagram illustrating the steps performed by the server of FIG. 1 to provide discounts, payments, or fees to users of social media;

FIG. 9 is a schematic diagram illustrating an exemplary embodiment of an auction system in which advertisers can compete for users of the system of FIG. 1 in the proximity of the advertisers;

FIG. 10 is a flowchart illustrating the steps performed by the server of FIG. 1 in the auction system of FIG. 9;

FIG. 11 is a flow diagram that illustrates steps of a method used in the system of FIG. 1 for implementing a barcode-based advertising system;

FIG. 12 is a flow diagram illustrating one way in which one embodiment of the system of FIG. 1 may allow user authentication for a service; and

FIG. 13 is a flow diagram illustrating the steps performed for wifi advertising according to one embodiment.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

### Basic Operation of the Advertising and Payment System

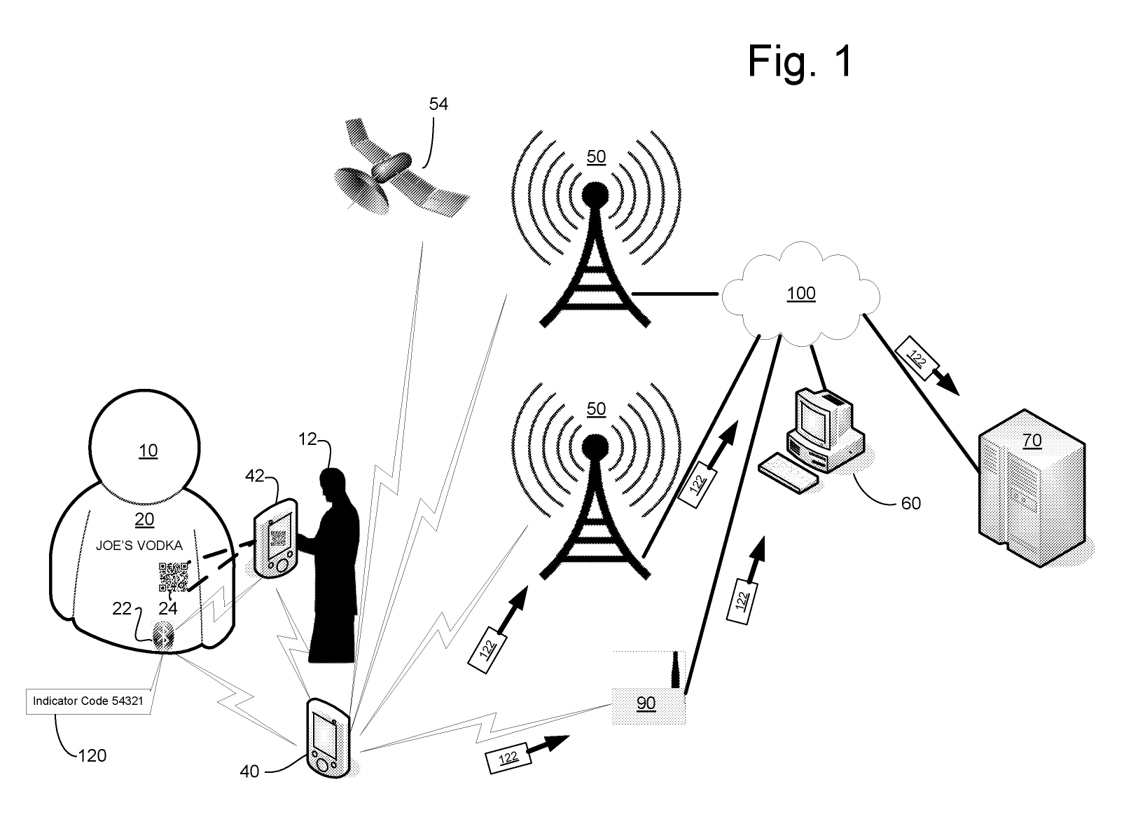

With reference to FIG. 1, a user 10 may wish to participate in an advertising system. In one embodiment, the user 10 may even be paid for travelling and displaying objects 20, such as a T-shirt as shown in FIG. 1, at certain locations. In other embodiments, some locations that the user 10 may travel to may provide more compensation than others. For example, the user 10 may have an advertising object 20 in the form of a T-shirt that displays Joe's Vodka. The user 10, for example may be paid one price for spending a certain amount of time in a mall, but an enhanced price for wearing an alcohol-related advertisement in a bar or entertainment establishment. However, it should be noted that, while a premium may be paid to the user 10 to wear the advertising object 20 at certain locations at certain times, advertisers may compensate the user for displaying the advertising object 20 at all locations where the user 10 may travel.

As those skilled in the art would recognize, many different types of advertising objects other than T-shirts could be used, by way of example, and not by way of limitation, caps, pants, water coolers, pet clothing, and the like, may also comprise advertising objects.

There has been a proliferation of electronic mobile platforms, such as, by way of example, and not by way of limitation, mobile phones, smartphones, feature phones, mobile tablets, iPhones®, iPads®, iPods®, Blackberrys®, personal data assistants (PDAs), tablet devices (tabs), and the like. In one embodiment, the user 10 with the advertising object 20 may carry an electronic mobile device 40 with them. In one embodiment, the electronic mobile device 40 may include a means for detecting whether the user 10 has or is displaying the advertising object 20. For example, in FIG. 1, the mobile device 40 detects the presence of an electronic indicator 22 connected to the advertising object 20, in the case of FIG. 1, being a T-shirt. In the embodiment of FIG. 1, a Bluetooth® device attached to the T-shirt serves as the electronic indicator 22. However, those skilled in the art would recognize that any type of electronic indicator 22 capable of connection to, or detection by, the mobile device may be used. For example, RFID technology, Dash 7, Zigbee, and/or low power USB, may be used instead of Bluetooth® technology. As explained below, the recent standard of direct wifi may be used instead of the above-listed standards.

The identifier code 120 associated with the electronic indicator 22 is recognized by the mobile device 40. As commonly provided in various mobile devices, the mobile device 40 has the ability to use various technologies for geolocation. Some of these technologies are described below with respect to geofencing. While many users of mobile devices today can perform tasks such as providing driving directions, viewing maps of their current location, and the like, there are a growing number of companies that offer location services for various mobile platforms and applications. One of those companies is ZOS Communications, located at 121 Gray Avenue, Suite 101, Santa Barbara, Calif., 93101. ZOS Communications, as an example, provides a cloud service allowing applications running on a mobile device's operating system to determine the location of the mobile device. One preferable method using the ZOS Communications system combines the ability to use the GPS network 54, triangulation between cell phone towers 50, and/or a wifi hub 90 to determine the location of the mobile device 40. The mobile device 40 has an application running on its operating system that is able to signal or “ping” the ZOS server, which would then provide data regarding the location of the mobile device 40, using one or a combination of the three above-described networks 54, 50 or 90.

In some embodiments, the user 10 may check-in by hitting a check-in button on the mobile device 40. The user 10 is given the option to select the location at which the advertising object 20 is being displayed. While the system does verify the check-in through location-based services described above, using the added optional check-in method allows the user 10 to have further confirmation of the record that the user 10 was displaying the advertising object 20 at a designated location.

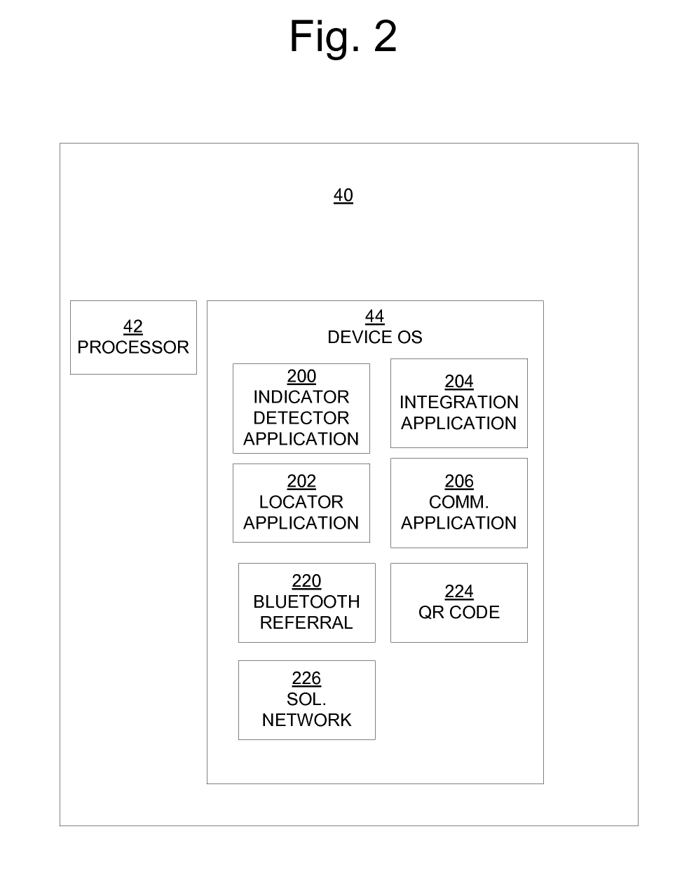

Referencing temporarily to FIG. 2, a block diagram illustrating some of the functional modules of mobile device 40 according to one embodiment is shown. Just about every modern mobile device has functions and features much like personal computing systems of yesterday and today. For example, just about every electronic mobile device 40 has a processor 42 and an operating system 44, such as Google's Android, Apple's iPhone® IOS, Apple's iPad® IOS, Apple's iPod® IOS, Blackberry OS, Qualcomm's Brew operating system, or Symbian operating system. Just as is the case on personal computers, mobile electronic operating systems 44 allow applications 200-206 to be written and installed on the mobile devices 40. Many mobile device applications, for example, may include many of the same types of utilities that are included on personal computers. More specifically, for the present embodiment shown in FIG. 2, applications may comprise, by way of example, and not by way of limitation, an indicator detector application 200, a locator application 202, an integration application 204, and a communication application 206.

Going through the functionality of each of applications 200-206, indicator detector application 200 may be configured to detect whether the user (10 in FIG. 1) is in possession of the advertising object (20 in FIG. 1). The indicator detector application 200 may be able to detect an indicator code (120 in FIG. 1), which identifies the advertising object 20. For example, the identity of the Joe's Vodka T-shirt in FIG. 1 is determined by the Bluetooth® or direct wifi identifier of “54321”, which indicates to the system that it is the T-shirt for advertising Joe's Vodka that the user 10 received and wishes to wear at a specified location.

Application 202 in FIG. 2 may communicate with the ZOS Communications system, which returns the geo-location of the mobile device 40. This return geo-location, along with the indicator code 120, may be fed into the integration application 204. The integration application may then package these two pieces of data for transmission through the internet from the mobile device 40 into an advertising location data package 122. In one embodiment, the advertising data location package 122 may comprise an XML stream, KML stream, or other type of data constructor known to those skilled in the art. The advertising data location package 122, may be transmitted through the cellular network (50 in FIG. 1), wimax (4G), or wifi network, to the internet (100 in FIG. 1) via a communication application 206 running in the operation system 44.

Referring back to FIG. 1, the communication application (206 in FIG. 2) may provide a secure socket layer (SSL) connection to track server 70 to send the data location package 122. The tracking server 70 records the locations and times of stay at those locations for each user 10 with the advertising object 20.

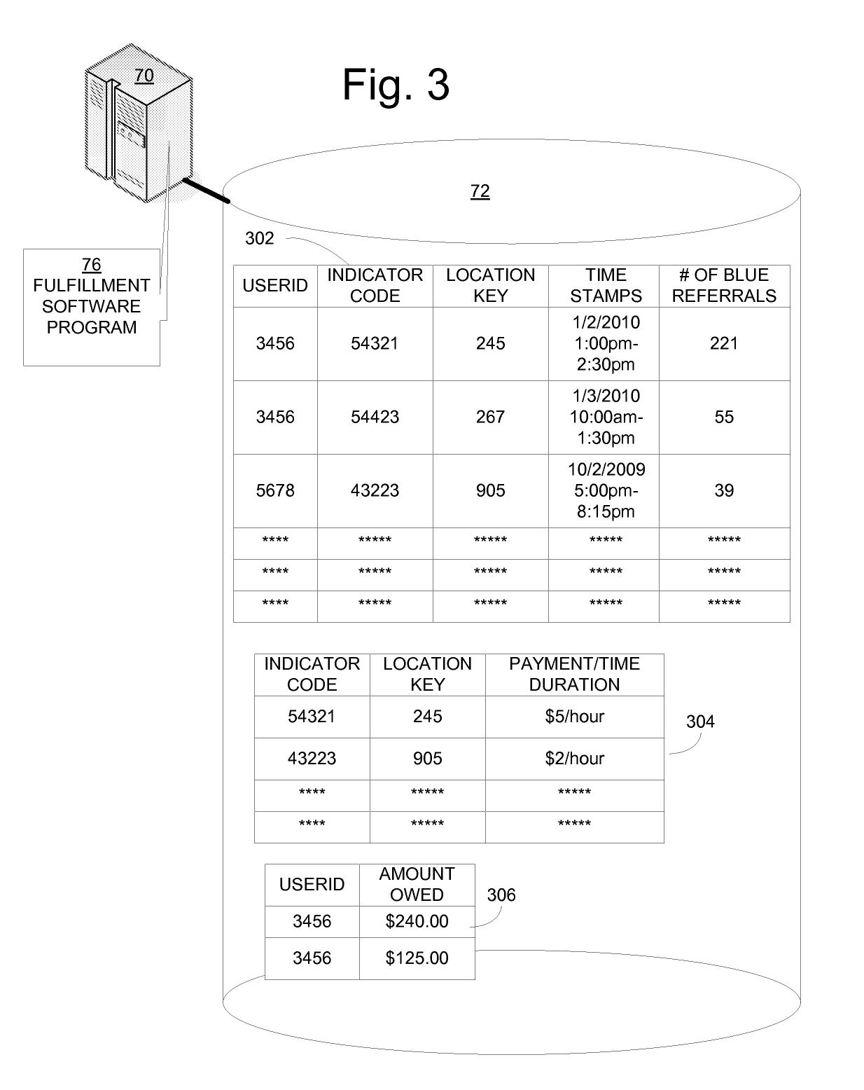

With reference to FIG. 3, a database entity diagram showing one embodiment of how the received data packages 122 may be stored is shown. The tracking server 70 may contain a mass storage device 72 that may contain one or more relational database tables 302-306. Stored in the relational database table 302 are the data location packages 122, which can be, in one embodiment, directly stored in XML or KML objects or, as an alternative, broken up into relational database records in native SQL format. As shown in FIG. 3, the data collected using the ZOS Communications system, or other location service as desired, along with the user ID, the advertising object indicator code, the time stamp indicating how long the user 10 stayed at the location indicated by a location key, is all stored in the database 302. The location key may comprise, for example, a key number for an advertiser-selected location that corresponds to a geo-fence of an area that an advertiser wishes the user 10 to go with the advertising object 20. Each geo-fence indicated by the location key signifies the geographic boundaries of a location of interest to potential and/or current advertisers for certain advertising objects 20. For example, an advertiser named Joe's Vodka may have selected a location key that signifies a geo-fence of a popular nightclub where vodka drinks may typically be sold. The advertiser may select, from a list of location keys, the location key for that particular nightclub as a place for users who select the Joe's Vodka T-shirt to frequent. Joes Vodka may be willing, for example, to pay a premium for the user 10 to wear the T-Shirt at the nightclub indicated by the location key. As shown in FIG. 3, the database 302 has stored the information that indicates that the user 10, who may have a user ID in the system of, for example, 3456, has been at location key 245, wearing advertising object 20 with a indicator code of 54321 for the Joe's Vodka T-shirt.

Each month, quarter, year, or time period as desired, a fulfilment system, which may or may not be an executable fulfilment software program 76 stored on tracking server 70, traverses the database 302 to calculate the amount owed to each user 10 for displaying the advertising objects 20 in the desired locations indicated by the location keys. The fulfilment software program 76 may use another database 304 containing the location keys and payment amounts for time that is allocated to each user for displaying the advertising objects 20 at the desired locations. Each location key may be associated in database 304 with the indicator code for an advertising object 20, and the amount that an advertiser is willing to pay per time that a user spends at a location indicated by the location key.

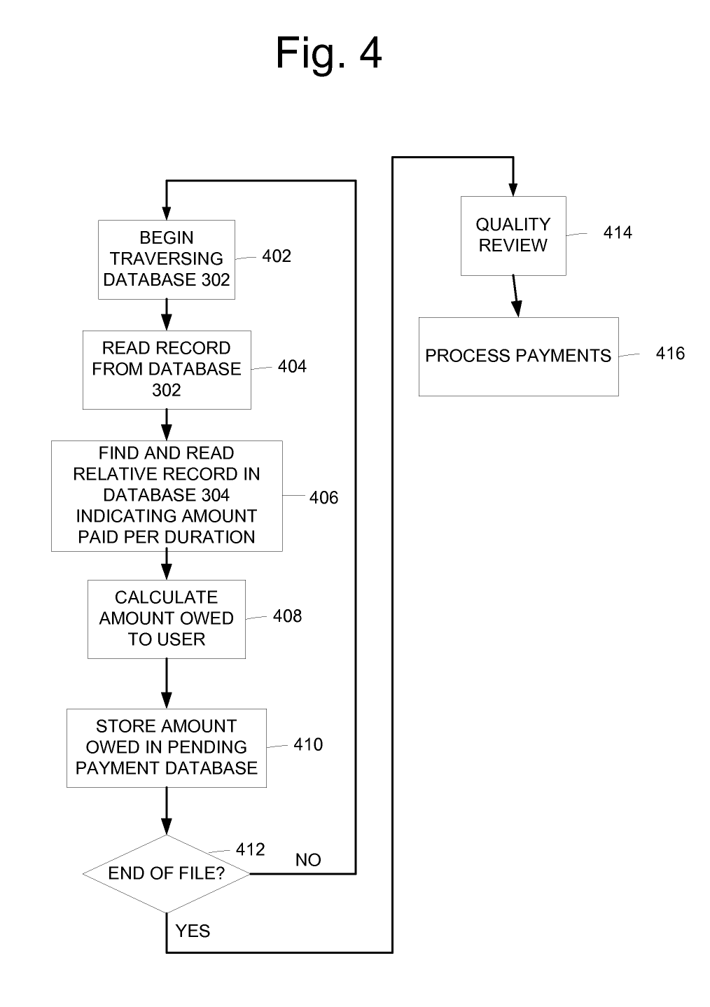

With reference to FIG. 4, a flow diagram illustrates the steps performed by such fulfilment software program 76 to determine the amount owed to each user 10 based on the data from database tables 302 and 304. The fulfilment software program 76 may be set, in one embodiment, to, for example, perform this task either on a monthly or quarterly basis, or other time frame, as desired. Starting with step 402, the fulfilment software program begins traversing database 302. In step 404, each record is read, and for user 10 indicted in the USERID field, the fulfilment software program 76 collects the indicator code, the location key, and the duration during which the user 10 for that record stayed at the relative location. In step 406, the fulfilment software program 76 finds the relevant indicator code and location key information in database 302 to retrieve the amount paid per duration for those keys. In step 408, if desired, the fulfilment software program 76 then calculates the amount owed to the user by multiplying the duration read from database 302 by the amount to be paid per duration of time. In step 410, if desired, the fulfilment software program 76 then stores the amount in a pending payment database (306 in FIG. 3) for quality control review before payments are approved. If the fulfilment software program 76 has not reached the end of database 302, step 412, the processing moves back to step 402. Otherwise, in step 414 the processed payments may be reviewed by an administrator to make sure, for example, there has been no hacking into the system or other problems. Next, in step 416, the payments may be processed physically, or in some embodiments, through electronic funds transfer (EFT). In one embedment, the users 10 may provide bank account or PayPal® account information for receiving payments. In yet another embodiment a debit card may be issued with the advertising object 20 to user that is credited with the payment amounts owed.

In some embodiments, instead of money paid, virtual currency may be paid, or rewards points, good toward merchandise, or other gifts and rewards. Alternatively, contests or sweepstakes may be conducted in the system. By way of example, and not by way of limitation, users 10 may compete by taking pictures or video at advertising locations which can be judged by other users 10, advertisers, or system operators.

Those skilled in the art would also recognize from the above description that a number of different compensation methods and number of users 10 can be employed, especially with respect to advertiser's potential desire to have part time or full time individuals or groups, or independent contractors, walk through certain areas or places at certain times. For example, and not by way of limitation, instead of a user 10 being allowed to go to specified locations as the user pleases, the advertiser may wish to provide full-time compensation to a user 10 to walk around a mall or amusement park all day, using the system and method described above to track said full time user 10.

In yet another alternative embodiment, some users 10 may be given incentives to display the advertising object 20 in specified locations for free. For example, existing systems, such that used by Foursquare®, provide points, badges and other incentives for users to check-in at various locations or to explore areas of cities and other attractions. Users 10 may be provided with point bonuses for example for displaying the advertising objects 20 while they are earning their Foursquare® points or badges.

It should be noted that in some embodiments, the advertising object 20 may or may not just provide static advertisements. For example, the advertising object may comprise a flexible display on a T-shirt or cap, that changes the advertising periodically, or wirelessly when desired. For example, the display on a T-shirt may display Joe's Vodka one day, or for one hour, and then Joe's Beer the next day or hour.

Further, the advertising objects 20 are not limited to just displaying lettering or graphics. Sound, touch, smell, or other interactivity, may be implemented. This may be useful to advertising of music artists, perfumes, tissues, or other types of interactive products.

It should also be noted that the emerging near field communication (NFC) technology allows for more secure and easy tap-to-connect implementation of the above-described system instead of using a Bluetooth® or direct wifi connection to pair the electronic indicator 22 to the mobile device 40. NFC technology has been heralded as a potential replacement for Bluetooth® pairing due to its ease use and enhanced security.

### Bluetooth or Direct Wifi Referral Advertising Subsystem

In some embodiments, advertisers may or may not desire to convey related and non-related advertisements to other Bluetooth® or direct wifi enabled devices situated around mobile device 40. With reference back to FIG. 2, a Bluetooth® or direct wifi referral application 220 (collectively called a “Bluetooth® referral application” herein) facilitates a method for sending advertisements, links, references, coupons and/or other information out to other devices in the same proximity as mobile device 40. Push or pull methods may be used for the sending of information to other users.

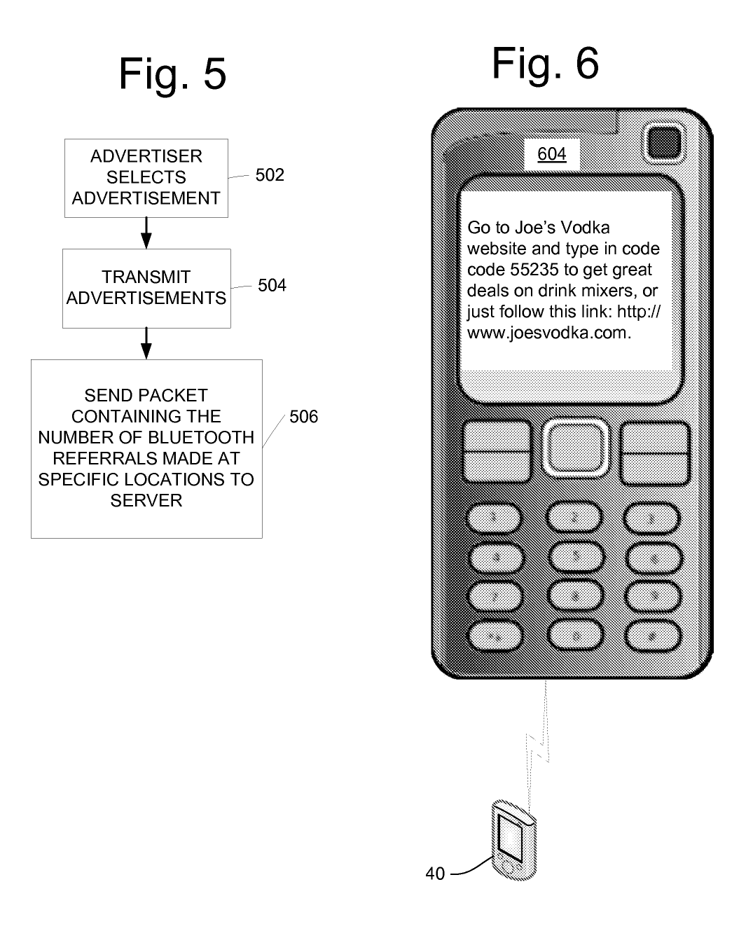

With reference to FIG. 5, a flow diagram illustrates the steps that may be performed by application 220 according to one embodiment. In step 502, the advertiser selects an advertisement capable of being stored and transmitted by the mobile device 40. In some embodiments the selected advertisement may or may not have anything to do with the advertising object 20. However, there may be advantages to such a relation. For example, in FIG. 1 using the Joe's Vodka example, the selected advertisement to transmit may relate to a coupon for Joe's Vodka or a drink mixer that can be used with Joe's Vodka. In other embodiments, the advertisement may be selected by a company that is compensating Joe's Vodka for use of their advertising bandwidth in the system to push non-competing products. In step 504, the selected advertisement is transmitted to all Bluetooth® or direct wifi enabled devices within the range of mobile device 40 for display to the users of those devices. In step 506, the mobile device 40 may then transmit in a data packet 122 an indication of the number of advertisements that were sent in a selected location key to be stored database 302 (FIG. 3). In this way, the user 10 not only may be compensated for displaying the advertising object 20 at a specific location, but the user 10 may also be compensated for sending referrals at a specific location. The number of referrals made at each location key is stored as shown in database 302. When the fulfilment software program 76 performs the payment processing function described above, there may be added compensation for each user whose mobile device 40 has sent out a certain number of referrals at a specific time or location. Alternatively, the database 302 may store the mere fact that referrals were sent out at a location if the Bluetooth® referral application 220 is not capable of counting the number of referrals sent.

In another embodiment, a person receiving the referral may be provided with an access code or link to a website. The link provided contains a unique code or extension that identifies the mobile device 40 that sent the referral. The tracking server 70 may receive the data regarding how many recipients access the web site with the unique referral code from the referral device, thereby provided the ability of the fulfilment software program 76 to compensate the user 10 based on the number of referral recipients who access the web link, code or extension. All of this data can be stored in database 302, and the amount of compensation per link can be stored in database 304 for adding to the compensation of the user 10 for providing the referrals.

In one embodiment, referrals containing web page references can be simplified to direct the user to a redirected domain address so that the receivers of the referral may more easily memorize the web address for the referral. For example, the system may provide a domain address such as www.bb.info that will redirect the user to Bestbuy.com when the user goes to a web browser and types in the simplified domain. In yet another embodiment, the referral recipient may be able to touch or click the domain address (or hyperlink) to direct their screen on their mobile device to access the web page located at the provided domain address or hyperlink.

With reference to FIG. 6, a diagram illustrates an example of such a referral 602 that may appear on the recipient's phone 604 after transmission by the mobile device 40. If the recipient were to link to the displayed website, or if the recipient visited the website and typed the displayed code, the code is recognized as comprising the unique code for referral by the mobile device 40 from which the referral was received, and the user 10's database record is appropriately set to reflect the fact that the user 10 caused the referral to the website.

In one embodiment, instead of having the mobile device 40 broadcast the referrals, the electronic indicator 22 can be set to broadcast the advertisements, reward the user 10 in the same way as specified above.

Those skilled in the art may recognize that many different uses of the referrals could be beneficial. For example, in fashion industry runway shows, many diverse fashions being displayed on models by many different designers are included. Reporters may get designers or fashions mixed up during a runway show. Each of the designers may include a Bluetooth®, direct wifi, or other broadcast device 22 on or with each of the garments being displayed. The broadcast would provide information on the garment being displayed as well as advertising and/or pricing information. Reporters and other observers may then have the information appear on their mobile devices for informational purposes.

As another example, many sporting events include participants, vehicles, and/or sports equipment provided by sponsors of the participants. While the equipment and/or clothing worn by the participants may have decals or other identifying insignia, it can be sometimes hard to see during play of the sport or game. The referral system may provide a way to broadcast the specific sponsor messages of the participants or of, for example, the arena where the sport is taking place to the mobile devices of spectators.

It should be noted that as new peer-to-peer technologies are implemented in mobile device technology, those technologies can be leveraged for advertising. For example, instead of using the Bluetooth® connection described above or wifi-direct technology described below, Qualcomm's recent proximal peer-to-peer system may be used. The Qualcomm system uses orthogonal frequency division multiplexing access (TD-OFDMA) technology, similar to the technology used in WiMax to allow peer-to-peer communications between mobile devices. TD-OFDMA may be used as the carrier to send advertisements between the mobile devices.

### Group Assembly Advertising

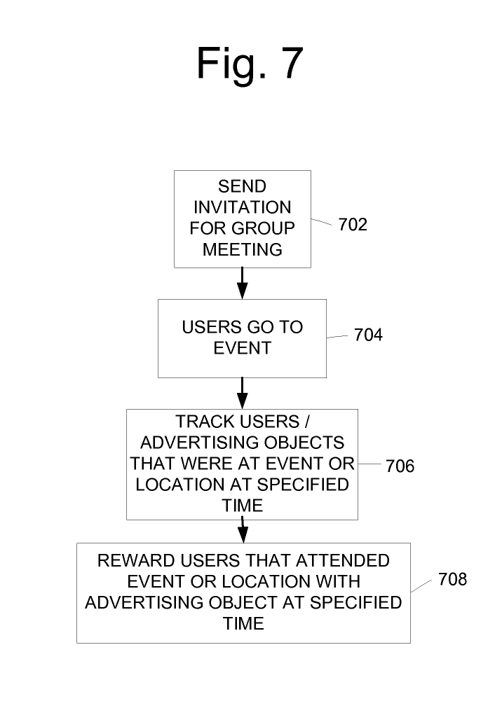

In one embodiment, there may be an incentive provided for groups of users 10 using the same or similar advertising objects 20 to assemble in one place to cause a greater advertising impact for an advertiser. For example, with reference to FIG. 7, a flow diagram illustrates the steps for providing such an incentive and/or extra compensation to the participants. In step 702, an advertiser may determine that it is advantageous for several users 10 to display the same or similar advertising objects 20 at an event or certain location at the same time, and therefore the server 70 may send out several invitations for users 10 who have been assigned the same or similar advertising objects 20 to go to such event or location on a certain date at a certain time. In step 704, each user who received such an invitation, which may have been either by e-mail, text message or otherwise, may then bring or wear the advertising object 20 to the specified event. In step 706, each advertising object 20 for the users 10 who received the invitation may be tracked as described above to determine which users actually did attend. As described above, there may be added incentives for users 20 to stay as a group at the event or location to which the users 10 were invited with their advertising objects. Finally, in step 708, each user 10 that fulfilled their obligation to go to the specified event or location may be rewarded with added compensation by updating database 302. For example, for the month that the event took place, each user 10 that showed up with Joe's Vodka T-shirt to, for example, a specified movie premier or grand opening would received added compensation. The fulfilment software program 76, during processing payments, would read the fact that a user 10 was invited to a specific event, and had the added compensation due record in database 302, and then provide for the added payment of the user 10 during processing of the user's payment.

In one embodiment, the in order to promote use of the system, a group of users 10 who spontaneously decide to get together with their advertising objects 20 at a location may be awarded bonuses or points for doing so, whether the advertising objects 20 are the same or not. For example, a group of users 20 may use the social media systems described below to form a group meeting in Central Park, N.Y., with their advertising objects 20. Tracking server 70 may recognize that all of the members of the group have met within Central Park, and update database 302 (FIG. 3) to reflect that each member of the group should receive a bonus.

### Social Media Integration

With the major emergence of social media, many advertisers may wish to leverage social media networking to further enhance their use of the described system. In one embodiment, there may be an incentive provided for users 10 not only to display the advertising objects 20 at specific locations, but also to take pictures or videos of the advertising object 20, either with the user 10 in the photograph or without, and to then place the resulting photograph on their social media web page. For example, the user 10 may have a picture taken of himself with the Joe's Vodka T-shirt, and the user 10 may place the photograph on his Facebook® page. The user will then add tracking server 70 as a Facebook® friend so as to give the administrators access to check if the photograph with the advertising object 20 has been posted. If so, for example, the user 10 may receive a further bonus for providing the photograph on his social media page. Further, the user 10, for additional points may make sure that the advertiser's name is in the photograph. In yet another embodiment, the user may include other member retailers that are members of the system in a photograph with the advertising object 20 for yet additional bonus points. In one embodiment, administrators may receive automatic updates from the users 10 when they post a picture or video to alert administrators.

In some embodiments, if the user 10 adds the advertiser as a friend to their social networking website, or as a follower for example, in the case of Twitter®, and the advertiser can then verify the presence of the above-mentioned picture, then the user 10 may receive added bonuses, points, or other incentives.

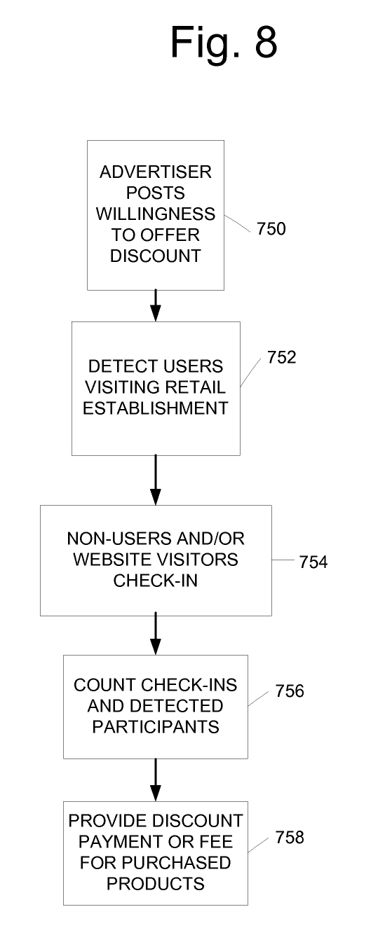

In another embodiment, there is a method and system providing an increasing group discount, payment, or fee can be integrated with the system. Either using social media, or other methods, such as text or voice, users 10 can obtain and increase discounts, payments or fees that may be offered to them by advertisers. With reference to FIG. 8, a flow diagram illustrates the steps performed by the server 70 to provide for such discounts, payments or fees to users 10. In step 750, and advertiser may post a notice on server 70 that such advertiser is willing to offer group discounts, payments, or fees according to the method described herein. For example, one or more users may then wish to take advantage of the discount, which includes a progressive discount the more users 10, or even non-users, who participate. A user 10 may either go directly to the retail establishment, or website, of the advertiser. However, the more users and non-users that show up at the retail establishment or visit the website at the same time, the bigger the discount that each of the users and non-users will receive, up to a predetermined maximum that may be set by the advertiser. In step 752, for each user 10 that shows up at the retail establishment, the server 70 can detect the user's presence using the tracking methods described above. In step 754, in the case of a website, and in the case of non-users, the participants may check-in, for example as with the Foursquare® site, or other social media or location-based services.

After counting the number of users 10 and non-users that have been detected at the retail location, web site, or have checked-in, step 756, a discount to all of the participants is provided as those users 10 and non-users purchase goods either at the retail establishment or online, in accord with the discount that advertiser has offered with the progressive discount, payment or fee based on the number of participants, step 758. In other embodiments, instead of discounts, progressive points earned, rewards, badges, credits or virtual currency can depend on the number of participants—e.g. increased mileage awards for credit card purchases. In one embodiment, a code or barcode is sent to an originator of the group who initially started the social media messages to form the group, wherein such code or barcode is presented to the retailer to facilitate the awarding of the discount, payment or fee. In another embodiment, such code can be sent directly to the retailer.

### Geo-Fencing Auction Subsystem

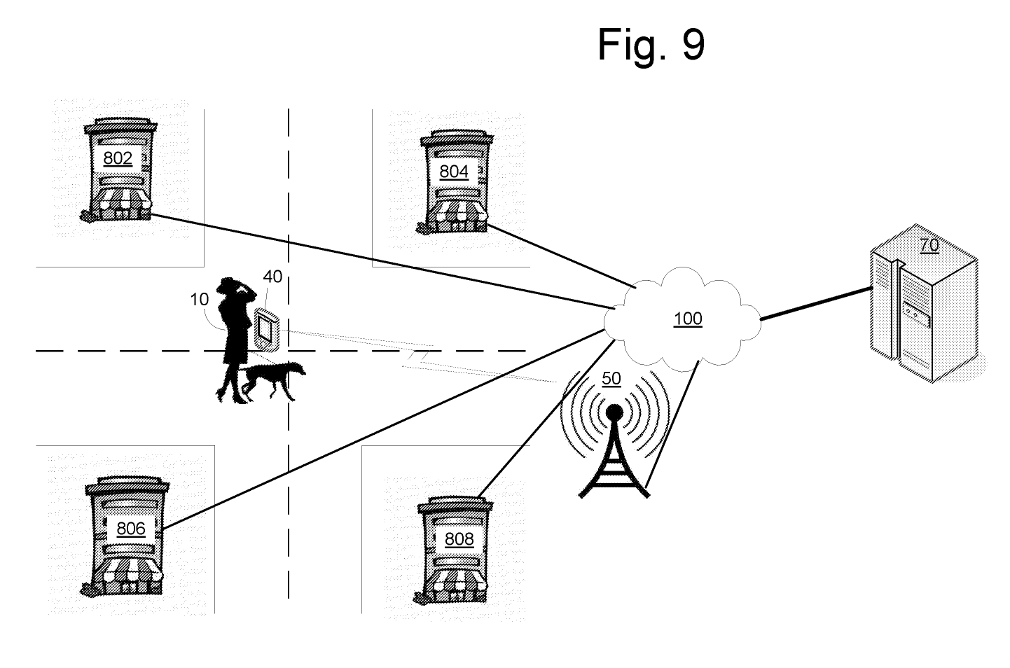

In one embodiment, the above-described system can provide new and unique ways to provide advertisers with the ability to compete for customers. As the system already has a built-in tracking system for tracking the users 10, there is an equal ability to determine if a user is near one, two or more of the advertiser's retail establishments, which can each be geo-fenced. With reference to FIG. 9, a schematic diagram illustrates an exemplary embodiment of an auction system in which advertisers 802-808 can compete for users 10 in the proximity of the advertisers. As described above, the tracking server 70 may be continuously tracking the location of a mobile device 40, and hence, the user 10 of the mobile device. Of course, the location keys kept by the server, as shown in FIG. 3, may relate to the geo-locations of the advertisers 802-808, many of which may have actual physical, or so-called brick-and-mortar, retail locations as shown in FIG. 9. When the server 70 is tracking the user 10 with the mobile device 40, the server 70 may detect that the user 10 is within a certain proximity of the one or more of the advertisers 802-808. When the user 10 is within such proximately, the server 70 may send an alert to each of the advertisers 802-808. The alert may be in the form of an e-mail, text message, instant message, notification, phone call, or a direct message to a designated proprietor or advertising agent of each advertiser 802, in real time. The alert may go to the advertiser's computer or mobile device. This would be an opportunity for one or more of the advertisers 802-808 to gain the attention of the user 10, knowing now that the user 10 is within the proximity of their shop. The server 70 may then provide an auction or mini-auction in real time to allow each of the advertisers 802-808 to bid to send a priority message to the user 10 while they are within the proximity of the advertisers 802-808. The auction may be automated such as that used by Google Adwords® in which minimum and maximum bids are set by advertisers. The biding may be regressive and advertisers may have the opportunity to set bid increment amounts.

Each advertiser may submit a bid to send a priority message to the mobile device 40, through the server 70, to obtain the attention of the user 10. In one embodiment, there can be a placing for each advertiser 802-808. For example, if there are four advertisers 802, 804, 806 and 808, each may send a bid to the server 70 to obtain the priority spot to send the message to the user 10 in real time. The server 70 may then prioritize the bids, in order form highest to lowest, and the advertiser (802 for example) with the highest bid may then have their alert, in the form of, for example, an instant message, text message or e-mail sent to the mobile device 40 in real time first. The alert may comprise one of the types described above sent to advertisers. Then the advertiser with the second highest bid (for example, advertiser 804) may then have their message sent next, and so on, until all the advertisers 802-808 who have bid in the auction have had their messages sent to the mobile device 40. In one embodiment, an advertiser may wish to cancel its bid at any time.

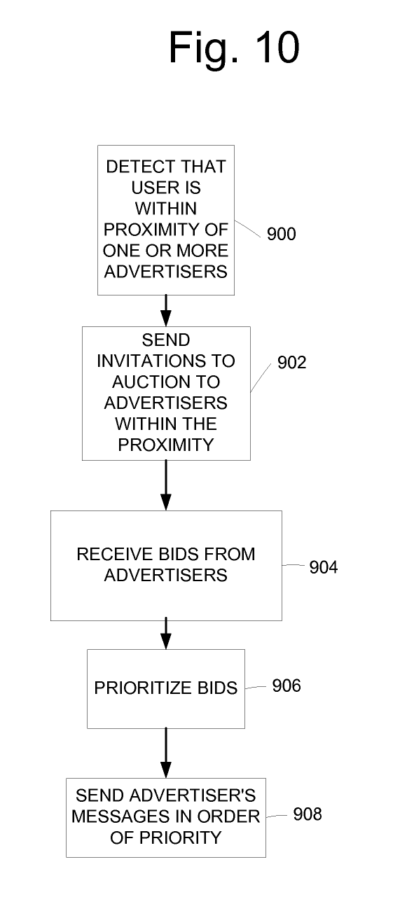

With reference to FIG. 10, a flowchart illustrates the steps performed by server 70 in the auction sub-system. In step 900, the server 70 detects that user 10 is within the proximity of one or more advertisers 802-808. As explained above, the server 70 is able to perform this step because it is able to calculate that the mobile device 40 is within a certain proximity of the geo-fence of the one or more advertisers 802-808 using the location services of the system explained above. In step 902, the server 70 then transmits invitations to each of the advertisers 802-808 with the proximity of the user 10. In step 904, the server 70 receives bids from each of the advertisers 802-808 that wish to bid in the auction. In step 906, the bids are prioritized according to bid amount. Finally, in step 908, each advertiser's message is sent to the mobile device 40, in the order of priority.

In one embodiment, each of the advertisers 802-808 have set up one or more messages within the server 70 that are to be sent once the auction is completed. However, in other embodiments, each of the advertisers 802-808 have the option of typing in custom messages to be sent in real-time that are sent with the bids, which could include, for example, on-the-spot coupons, or other incentives to try to get the user 10 to come into their store. In other embodiments, the advertisers 802-808 pre-set up their bids so that when a user 10 does enter into their proximity, the auction is essentially already run automatically by the system, and the mobile device 40 receives the advertiser messages in priority according to the bid amounts. Each advertiser 802-808 has the ability to update their bids on a web page associated with server 70 to try to outbid the other advertisers 802-808 in their proximity. In yet another embodiment, the when the advertisers 802-808 submit their bids in real time, similarly each advertiser 802-808 may have the ability to see the other submitted bids so they can outbid them in real time.

In one embodiment, the geo-fencing system described above may be leveraged using the MILO system by EBAY®. Using MILO, users of mobile devices are able to type in a product or service they are interested in, and MILO recognizes the user's location using GPS, multilateration (GSM localization), control plane locating local range near location-based service (NLBS) technology, or operator and GPS-independent location service based on access into the deep level telecoms network (SS7). Further, either network-based, handset-based, SIM-based, or a hybrid of these systems, may be used for tracking the mobile device 40. However, unlike the current MILO system, the system described herein may use an automatic feature to determine a user's interests. For example, when the user 10 signs up to receive the advertising object 20, the user 10 provides one or more preferences as to the type of product or service the user wishes to advertising. For example, the user 10 of FIG. 1 selected vodka as the product the user 10 wish to promote. The server 70 stores the user preference from which it can be inferred that the user 10 likes to drink vodka. Using MILO or a similar system, when the user 10 happens to travel near a location providing promotions or other sales activity relating to vodka, such as a liquor store, then the user 10 may automatically receive promotions for vodka, vodka mixes, or other vodka related products on their mobile device 40. This would be the case for whatever preferences the user indicated during sign-up for the system. Also, competing products may be promoted in a similar way. For example, if the user 10 had a preference for Nike® shoes, then promotions may be forwarded to the user's mobile device 40 for Adidas® shoes, without the need to request such information as with the current MILO system. Further, users 10 of the system may receive additional rewards points if they actual go and purchase one of the products that are promoted in this way. In one embodiment, voice commands may be used for the promotions for safety concerns when the user 10 is driving. A flag may be automatically set when the mobile device 40 is travelling more than a certain speed.

In yet another embodiment, the user 10 can get additional points without having to purchase the item by going into the retail establishment and scanning the barcode off of the promoted product. This will encourage more foot traffic into the retail establishment, and actual handling of the promoted product by the user 10, which is a valuable way to promote the product for which retailers may pay a great deal of advertising revenue.

### Barcode and QR Code Based Advertising

One of the latest trends is to provide the capability to mobile devices to take a picture or scan of a barcode or QR code, which causes the mobile device to provide useful information. Persons with mobile devices have the option of downloading barcode and QR code reading applications to their mobile devices from a variety of companies to configure a variety functionalities. For example, some such applications allow users to scan universal product code (UPC) labels, and the applications would then search the web for competing prices, product information, or location of item for the scanned UPC label. With reference back to FIG. 1, in one embodiment, a barcode or QR code 24 (collectively called a barcode herein), preferably of a 3D type, may be included on the advertising object 20. For example, the Joe's Vodka T-shirt in FIG. 1 has a 3D barcode 24 printed or affixed directly on the T-shirt and/or merchandise.

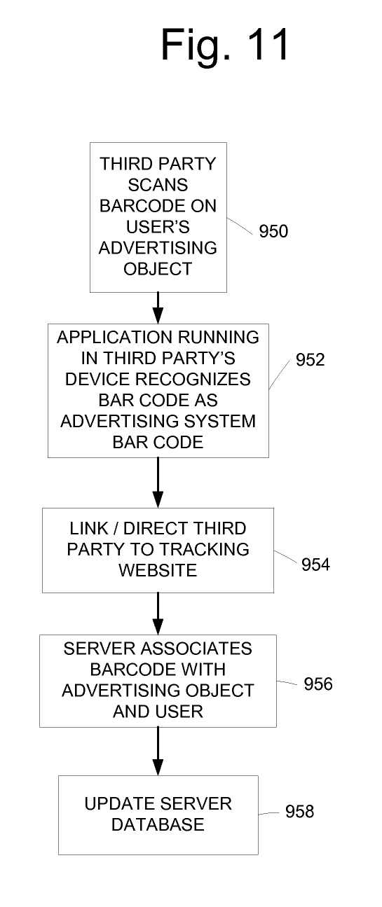

With reference to FIG. 11, a flow diagram illustrates the steps of a method used in the system for implementing a barcode-based advertising system. In step 950, a user 10 may have incentive to get third parties (12 in FIG. 1) to scan the bar code 24 on the advertising object 20 to earn added bonuses, rewards points, credits or virtual currency in the above-described system. For example, a user 10 may try to get a third party 12 inside a grocery store to scan the barcode 24. Next, in step 952, one of the widely distributed barcode applications running on the third party's mobile device (42 in FIG. 1) may have an sub-module added to recognize that the barcode 24 that is scanned by the third party relates to the system running in server 70. In one embodiment, in step 954, the application on the third party's device 42 may automatically be connected with sever 70, through the internet 100. Alternatively, a link to a website running on server 70 may be provided, or a code that the third party 12 can manually enter on the website on server 70. Of course, the third party 12 may be provided incentives to do so, such as coupons, reward, credits, virtual currency or points that may be offered to the third party 12 to follow through with visiting the website on server 70.

In step 956, server 70 recognizes the embedded barcode value, embedded link code, or code typed in by the third party 12 as being associated with the advertising object 20 possessed by user 10. For example, the server 70 may keep track of the code represented by barcode 24 in database 302 (see FIG. 3), and search the database 302 to associate the advertising object 20 and the user 10 with the scanned barcode 24.

Finally, in step 958, the result of such scanning by the third party 12 of the barcode scanning, and the server's 70 associating the advertising object 20 and the user 10, is that the server 70 will update the database 302 to reflect the number of such scans with the user 10, so the user 10 is provided with added compensation or added points bonuses by fulfilment software program 76.

In one embodiment, over and above the reading of the barcode 24 by the third party's device 42, the indicator code 120 of the electronic indicator 22 may be broadcast to the third party device 42. For example, for Bluetooth® types of electronic indicators 22, the Bluetooth® indicator code 12 may be transmitted to the third party mobile device 42, which may also include advertising to display on the third party device 42. In yet another embodiment, the barcode 24 may not even be needed if the indicator code 120 alone is broadcasted to the third party device 42, after which the steps of FIG. 11 are then processed. In yet another embodiment, the mobile device 10 of the user 10 may broadcast the indicator code 120 to the third party device 42, after which the steps of FIG. 11 are then processed.

Further, in one embodiment, the user 10 may get additional points or compensation if the user goes to a designated retail location, and scans UPC codes at the retail location. There may be advantages to having the users 10 perform such a task. The scanning of such UPC labels from the designated location may be a way to confirm and provide a system check-in to make sure the user is at the location indicated by the location key in database 302. Further, after a user 10 scans the UPC label of a product, server 70 may provide added incentive in the form of added compensation, rewards, credits, badges, virtual currency or points if the user types in the price of the product for the scanned UPC label. This way, a product price database can be formed in server 70, that can be used for comparison shopping or the like.

Further, the barcodes 24 on advertising objects carried by other users 10 may be scanned wherein each of the users 10 may, in sense, scan each other at different locations, to show that the users 10 have been at those locations together with their advertising objects 20. Contests and games may thus be run on server 70, wherein users may win compensation or points, for example, if they achieve the most number of concurrent location scans at locations with other uses with advertising objects 20.

### Bluetooth and Direct Wifi Security

In one embodiment, the indicator detector application (200 in FIG. 2) may provide security for the user any type of mobile services, such as mobile payment, mobile banking, social media login, or any type of service requiring user identification. Referring back to FIG. 1, when the electronic indicator 22 is in proximity to the electronic mobile device 40, the indicator detector application 200 is able to confirm that the user 10 is the person authorized to use many services.

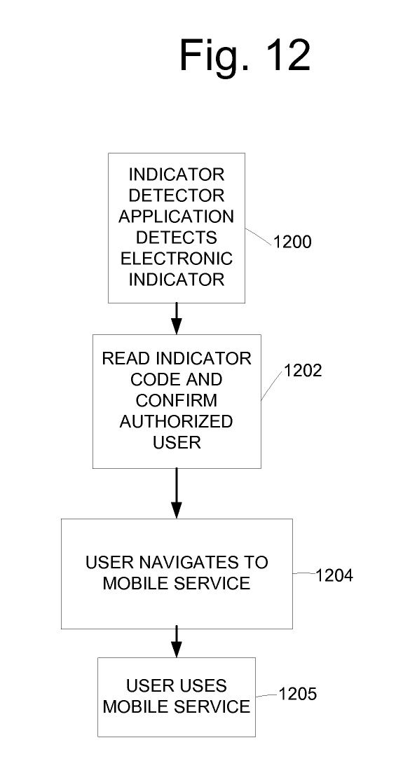

As an example, with reference to FIG. 12, a flow diagram illustrates one way in which this embodiment may allow user authentication for a service. In step 1200, the indicator detector application 200 detects that the electronic indicator 22 is within proximity of the mobile electronic device 40. In step 1202, the indictor detector application 200 reads the indicator code of the electronic indicator 22, and confirms that the indicator code is associated with the user 10. This step confirms that the user 10 is authorized to use any mobile services associated with that user 10. In step 1204, the user may navigate to an application or web page on the mobile device 10 that requires user authentication. For example, the user may pick a FACEBOOK icon on the mobile desktop of the mobile device 40 to navigate to their FACEBOOK account. Normally, before the present invention, users were required to type in login information, which could be compromised through phishing or other schemes by which malware may obtain passwords for forwarding to scam artists, who could then use that information to fraudulently login to users' services. However, using the presently described system, the indicator detector application 200 has already confirmed the authenticity of the user by means of connection with the electronic indicator 22. Having confirmed the authenticity of the user 10 through this method, the FACEBOOK application in this example, would check with the indicator detector application 200 to confirm the authenticity of the user 10 before taking the user 10 directly to the FACEBOOK account. This bypasses typing in of ID and password information that could be phished or hacked, thereby ease of use for the user, and better security.

In yet another embodiment, the mobile service may still require ID and password authentication. However, the method of FIG. 12 may further add yet another hard security check to authenticate the user to make sure that the user's ID and password are not being used after being compromised by a hacker. Essentially, the system thereby may provide what is know as two-factor authentication.

Of course the above example using FACEBOOK is merely an example of use of this method. With the current climate of major problems with identity theft, the above-described method can be even more useful with regard to bank transactions, mobile payment transaction and the like. For example, before a user conducts mobile payments using their mobile electronic device 22, the authentication method described in FIG. 12 may be used to make sure the user 10 is authorized. In some instances, the barcode that would normally appear on the user's mobile electronic device 22 would not even appear to complete a mobile payment transaction unless the authentication method of FIG. 12 is successful.

In yet another embodiment, instead of, or in addition to, using the indicator detector application 200, banks and other mobile service providers may include instructions within their mobile applications to perform the steps of FIG. 12. For example, a bank may wish to use the method of FIG. 12 to further authenticate the user 10 after or before the user 10 is allowed to type in their ID and password information to access their bank account form the mobile device 40.

### Using Wifi-Direct Technology

In one embodiment, wifi-direct technology implementation used between mobile devices can provide further capabilities to the above-described systems. For example, instead of using a Bluetooth-type indicator, or other near-field technology, the electronic indicator 22 and the mobile device 40 may be each configured to use wifi-direct technology for communications, instead of, for example Bluetooth or NFC technologies. This may also be the case with respect to the above-described geo-fencing auction system. Instead of going through a wide-area network, the geo-fencing auction system may be implemented through the wife-direct system. This allows for more reliable connections between the mobile device 40 and the advertisers competing in the auction. Further, the referral advertising system described above may be implemented using wifi-direct technology. For example, if wireless application protocol (WAP) security is implemented in mobile devices, an opt-in option may allow for broadcast of advertising messages to in-situ mobile devices.

Wifi tag technology may thus be implemented to provide the same services as the Bluetooth-type indicator described above. The wifi tag would identify the advertising object 20 instead of using Bluetooth technology. Wifi tags are readily available from AeroScout, Inc., 1300 Island Drive, Suite 202, Redwood City, Calif. 94065, which can be configured to work with the mobile device 40 and the applications of the currently described system.

### Wifi Advertising

In another embodiment, the wifi MAC addresses of wifi networks at business establishments may be used to indicate the business or advertiser at which the mobile device 40 is located. For example, referring back to FIG. 9, the user 10, may decide to walk into one of the advertiser business locations 802-808.

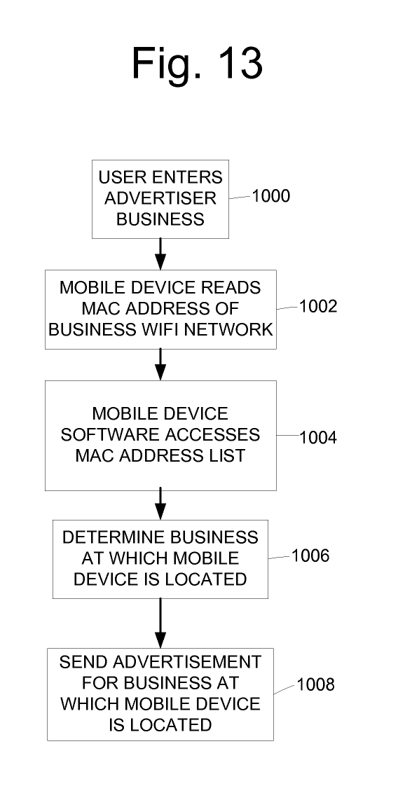

With reference to FIG. 13, a flow diagram illustrates the steps for wifi advertising according to one embodiment. For example, at step 1000, if the user 10 walks into business location 802, that business location may have a wifi network. In step 1002, in one embodiment, one of the applications, for example, the integration application 204, reads the MAC address of the wifi network at a business location at which the mobile device 40 is located. In step 1004, the integration application 204 may then access server 70 on the network, or another internet server that stores MAC addresses of wireless networks at business locations, to determine the business at which the mobile device 40 is located. For example, there are many internet services that list MAC addresses of businesses that have wifi networks, including, for example, wifi.com, wifidirectory.com, wififreespot.com, and hotspot-locations.com. In step 1006, each of the lists that can be obtained from these internet servers may allow the integration application 204 to determine the business in which the mobile device 40 is located. In step 1008, after such determination is made, the server 70 may then send directed advertisements, including, for example, coupons or discount offers, to the mobile device 40 for the user to take advantage of depending on the business location of the mobile device 40.

The various embodiments described above are provided by way of illustration only, and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. An apparatus for tracking an advertising object, comprising:
a mobile device capable receiving an identification code to identify the advertising object;
an identification device associated with the advertising object capable of transmitting the identification code to the mobile device;
a location media capable of providing location information to the mobile device;
a first set of executable instructions capable of executing on a mobile device to detect the reception of the identification code, and forwarding the identification code and the location information to a server that is capable of storing the location information and the identification code.
